(19) United States
(12) Patent Application Publication
(10) Pub. No.: US 2019/0291390 A1
(43) Pub. Date: Sep. 26, 2019

(54) POLYMER INTERLAYERS COMPRISING UV ABSORBERS

(71) Applicant: Solutia Inc., St. Louis, MO (US)

(72) Inventors: Benjamin Bristol Thompson, Framingham, MA (US); John Joseph D'Errico, Glastonbury, CT (US)

(73) Assignee: Solutia Inc., St. Louis, MO (US)

(21) Appl. No.: 16/439,876

(22) Filed: Jun. 13, 2019

Related U.S. Application Data
(62) Division of application No. 14/566,683, filed on Dec. 10, 2014.
(60) Provisional application No. 61/914,144, filed on Dec. 10, 2013.

(51) Int. Cl. B32B 17/10; C08K 5/134; C08K 5/07; C08K 5/3477; C08K 5/357; C08K 5/315; C08K 5/3475; C08K 5/1575

(52) U.S. Cl. CPC B32B 17/10678; B32B 2605/08; C08K 5/1345; C08K 5/07; C08K 5/3477; C08K 5/357; C08K 5/315; C08K 5/3475; C08K 5/1575; B32B 17/10137; B32B 17/10036; B32B 17/10091; B32B 17/10788; B32B 17/1077; Y10T 428/269; Y10T 428/3163; B32B 2307/71; B32B 2605/006; Y10T 428/24967; Y10T 428/266; B32B 17/10761

(57) ABSTRACT

A UV stable polymer composition comprising a poly(vinyl acetal) resin, a plasticizer and at least one UV absorber, wherein the ultraviolet absorber comprises structure (1)

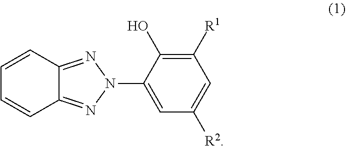

### CROSS REFERENCE TO RELATED APPLICATIONS

This application is a divisional of U.S. application Ser. No. 14/566,683 filed Dec. 10, 2014, which claims priority from U.S. Provisional Application Ser. No. 61/914,144 filed Dec. 10, 2013, the entirety of which is incorporated herein by reference.

### BACKGROUND OF THE INVENTION

### Field of the Invention

This disclosure is related to the field of polymer interlayers for multiple layer panels and multiple layer panels having at least one polymer interlayer sheet. Specifically, this disclosure is related to the field of polymer interlayers comprising UV absorbers and UV stable polymer sheets.

### Description of Related Art

Multiple layer panels are generally panels comprised of two sheets of a substrate (such as, but not limited to, glass, polyester, polyacrylate, or polycarbonate) with one or more polymer interlayers sandwiched there between. The laminated multiple layer glass panels are commonly utilized in architectural window applications and in the windows of motor vehicles and airplanes, and in photovoltaic solar panels. The first two applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces. Additionally, the interlayer may also give the glass a much higher sound insulation rating, reduces UV and/or IR light transmission, and enhances the aesthetic appeal of the associated window. In regard to the photovoltaic applications, the main function of the interlayer is to encapsulate the photovoltaic solar panels which are used to generate and supply electricity in commercial and residential applications.

In order to achieve the desired and optimal optical properties (such as color and clarify) for the glass panel and to prevent chemical degradation, fading and/or color change of the interlayer when exposed to ultraviolet (UV) rays from sunlight, it has become common practice to utilize ultraviolet absorbers in interlayers. These layers of the interlayer are generally produced by mixing a polymer resin such as poly(vinyl butyral) with one or more plasticizers and melt processing the mix into a sheet by any applicable process or method known to one of skill in the art, including, but not limited to, extrusion, with the layers being combined by processes such as co-extrusion and lamination. Other additional ingredients may optionally be added for various other purposes. After the interlayer sheet is formed, it is typically collected and rolled for transportation and storage and for later use in the multiple layer glass panel, as discussed below.

Contemplated polymer interlayers include, but are not limited to, polyvinyl acetals (PVA) (such as poly(vinyl butyral) (PVB) or poly(vinyl isobutyral), an isomer of poly(vinyl butyral) (which may be referred as PViB or PVisoB), polyurethane (PU), poly(ethylene-co-vinyl acetate) (EVA), polyvinylchloride (PVC), polyethylenes, polyolefins, ethylene acrylate ester copolymers, poly(ethylene-co-butyl acrylate), copolyesters, silicone elastomers, epoxy resins, and any acid copolymers such as an ethylene/carboxylic acid copolymer and its ionomers, derived from any of the foregoing possible thermoplastic resins. PVB and its isomer (polyvinyl isobutyral (PVisoB)), EVA, ionomers, and polyurethane are particularly useful polymers generally for interlayers.

Multilayer laminates can include multiple layer glass panels and multilayer polymer films. In certain embodiments, the multiple polymer films in the multilayer laminates may be laminated together to provide a multilayer film or interlayer. In certain embodiments, these polymer films may have coatings, such as metal, silicone or other applicable coatings known to those of ordinary skill in the art.

The interlayer may be a single layer, a combination of more than one single layer, a multilayer that has been coextruded, multiple layers laminated together to form a multilayer interlayer, a combination of at least one single layer and at least one multilayer, or a combination of multilayer sheets.

The following offers a simplified description of the manner in which multiple layer glass panels are generally produced in combination with the interlayers. First, at least one polymer interlayer sheet (single or multilayer) is placed between two substrates and any excess interlayer is trimmed from the edges, creating an assembly. It is not uncommon for multiple polymer interlayer sheets or a polymer interlayer sheet with multiple layers (or a combination of both) to be placed within the two substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by a high temperature and pressure lamination process, or any other method known to one of ordinary skill in the art such as, but not limited to, autoclaving.

The “Registration, Evaluation, Authorization and Restriction of Chemicals” (REACH) is a regulation of the European Union governing the production and use of chemicals on the basis of their impact on the environment and human health. Substances shown to exceed certain criteria are given persistent, bio-accumulative, and toxic (PBT) status. Chemicals with PBT status can be placed on an authorization list, which will eventually lead to the substances being banned for use and production in the European Union, and possibly in other world areas. Certain UV absorbers (UVAs), such as UVAs in the hydroxyphenyl-benzotriazoles class, have been given PBT status and it is possible that it may be banned from use by 2018. One specific UVA, 2-2H-benzotriazol-2-yl)-4,6-ditertpentylphenol (Tinuvin™ 328), is a UVA currently used in some PVB interlayers, such as interlayers for use in architectural applications (i.e., windows, ballustrades, sunlights, and the like), has been given PBT status. Another UVA in the hydroxyphenyl-benzotriazoles class, phenol, 2-(5-chloro-2H-benzotriazole-2-yl)-6-(1,1-dimethylethyl)-4-methyl (Tinuvin™ 326) is used in some PVB interlayers for use automotive applications, such as windshields. It has not yet been given PBT status, but it is possible that it will be in the future. Therefore, there is a need to find a suitable replacement UVAs for use in these PVB interlayers in case the existing UVAs are banned for use in interlayers and other applications.

Replacement UVAs must provide the desired UVA performance while also not adversely impacting other properties, such as optical properties (% Tᵤᵥ, YI and % Haze) and adhesion of the interlayer. Depending on the application, different properties are required. For example, for interlayers used in various applications, potential replacement candidates must be able to provide a UV light transmission (% Tᵤᵥ) of about 12% or less, depending on the required properties for the specific application. Replacement candidates for either application must also not interfere with adhesion (of the interlayer to glass or other substrates) or increase haze or yellowness index (YI), as well as not affecting other performance or mechanical properties of the PVB interlayers.

Additionally, interlayers may be used in multiple layer glass panels having at least one substrate comprising a high ultraviolet (UV) transmission substrate (such as a glass sheet). In these applications, conventional polymer interlayer materials can significantly discolor or yellow after extended exposure to sunlight or other UV light sources. Multiple layer glass panels using conventional glass (such as soda lime glass) also discolor or yellow, but at a much lower rate due to the lower UV light transmission provided by conventional soda lime glass. Thus, there is also a need to provide a polymer interlayer that does not yellow or have higher levels of color, particularly when exposed to higher levels of UV light.

Summarized, optical quality defects such as color (YI) and clarity (haze) as well as UV light transmission and chemical degradation are common problems in the field of multiple layer glass panels, and may be more pronounced in particular applications or configurations upon exposure to sunlight. Optical quality is especially important in applications such as windshields or windscreens, as well as windows, ballustrades, sunlights and other architectural applications, which require high levels of optical or visual quality. Further, there is a need to find replacement UVAs that are considered safe for use in interlayers. Accordingly, there is a need in the art for UVAs that are stable and compatible with the polymer interlayer and which do not cause higher levels of color or defects without a reduction in optical, mechanical, and acoustic characteristics of a polymer interlayer.

### SUMMARY OF THE INVENTION

Because of these and other problems in the art, described herein, among other things is a UV stable polymer interlayer. In embodiments, a UV stable polymer interlayer comprises: a poly(vinyl acetal) resin; a plasticizer; and an ultraviolet absorber selected from hydroxyphenyl benzotriazoles, hydroxyphenyl triazines, benzophenones, cyanoacrylates, benzoxazinones, benzylidene malonates, and salicylate ester UV absorbers and combinations of the foregoing UV absorbers.

In embodiments, the UV absorber is a hydroxyphenyl triazine UV absorber and is present in an amount of from about 0.01 to about 10 wt. %. In embodiments, the UV absorber is a benzophenone UV absorber and is present in an amount of from about 0.01 to about 10 wt. %. In embodiments, the UV absorber is a cyanoacrylate UV absorber and is present in an amount of from about 0.01 to about 10 wt. %. In embodiments the UV absorber is a benzoxazinone UV absorber and is present in an amount of from about 0.01 to about 10 wt. %.

In an embodiment, a UV stable polymer interlayer comprises: a poly(vinyl butyral) resin; a plasticizer; and an ultraviolet absorber comprising structure (1)

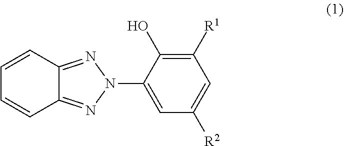

wherein R¹ and R² are each independently a C₁ to C₄₀ substituent, and at least one of R¹ and R² comprises an aryl substituent.

In embodiments, the ultraviolet absorber comprises structure (2)

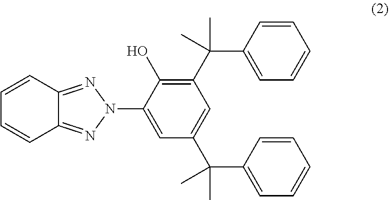 [SMILES: CC(C)(c1ccccc1)c1cc(-n2nc3ccccc3n2)c(O)c(C(C)(C)c2ccccc2)c1]

or structure (3)

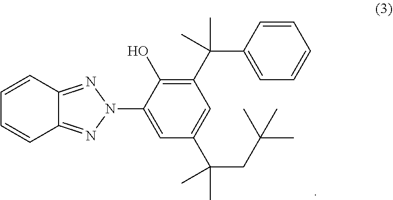 [SMILES: CC(C)(C)CC(C)(C)c1cc(-n2nc3ccccc3n2)c(O)c(C(C)(C)c2ccccc2)c1]

In embodiments, the ultraviolet absorber is present in an amount of 0.01 to about 10 wt. % and comprises 2-(2H-benzotriazol-2-yl)-4,6-bis(1-methyl-1-phenylethyl)phenol or 2-(2H-Benzotriazol-2-yl)-6-(1-methyl-1-phenylethyl)-4-(1,1,3,3-tetramethylbutyl)phenol or a mixture thereof.

In an embodiment, a UV stable polymer interlayer comprises: a poly(vinyl butyral) resin; a plasticizer; and an ultraviolet absorber comprising 2-(2H-benzotriazol-2-yl)-4,6-bis(1-methyl-1-phenylethyl)phenol or 2-(2H-Benzotriazol-2-yl)-6-(1-methyl-1-phenylethyl)-4-(1,1,3,3-tetramethylbutyl)phenol or a mixture thereof.

In embodiments, the ultraviolet absorber is present in an amount of 0.01 to about 10 wt. %. In embodiments, the polymer interlayer has a % T of at least 80% (ASTM D1003-Procedure B using Illuminant C), a % Tuv is less than or equal to 12 (as measured by ISO13837 Convention A on a 30 mil interlayer) and a yellowness index (YI) of less than or equal to 2 (as measured by ASTM D1925 on a 30 mil interlayer).

In an embodiment, a multiple layer glass panel comprises the UV stable polymer interlayer.

In certain embodiments, the rigid substrate is glass. In other embodiments, the panel may further comprise a photovoltaic cell, with the interlayer encapsulating the photovoltaic cell.

### BRIEF DESCRIPTION OF THE FIGURES

FIG. 1 is a graph showing the % Tᵤᵥ Change after WOM Exposure.

FIG. 2 is a graph showing the YI Change after WOM Exposure.

### DESCRIPTION OF THE PREFERRED EMBODIMENT(S)

Described herein, among other things, are UV stable compositions comprised of a poly(vinyl acetal) resin, a plasticizer, and a UVA absorber, wherein the composition has excellent clarity and color and provides the required UV absorbance. The composition may be used, for example, in a polymer interlayer. The use of a certain UV absorber herein significantly improves the color of the polymer interlayer compared to interlayers with other UV absorbers and helps prevent degradation. Additionally, the use of certain UV absorbers does not adversely impact other properties of the interlayer, such as adhesion, color, haze, light transmission as well as other properties. The UVAs also protect the interlayer as well as providing protection to both people and materials from the UV light.

It has been discovered by the inventors that a small amount of certain UV absorbers, when added to the mixture of resins and plasticizer(s) prior to extrusion, dramatically improves some of the properties of the final polymer composition or polymer interlayer, such as % Tᵤᵥ, without adversely affecting other properties. The use of certain specific UV absorbers also prevent or reduce the amount of yellowing (or color) of the interlayer caused by the UV light compared to other UV absorbers. In general, the addition of UV absorbers to polymer interlayers increases the color of the interlayer, at least a small amount, since many of the UV absorbers have some level of color. But the use of certain UV absorbers may increase the color (yellowness) or YI after exposure to UV light or radiation.

In other embodiments, the interlayer material can include an additive that provides UV absorption while also inhibiting UV light-induced chemical reactions from occurring which would otherwise results in discoloration of the interlayer material. In some embodiments, the additive includes, but is not limited to, a hydroxyphenyl-benzotriazole, such as a 2-(2H-benzotriazol-2-yl)-4,6-bis(1-methyl-1-phenylethyl)phenol, a 2-(2H-Benzotriazol-2-yl)-6-(1-methyl-1-phenylethyl)-4-(1,1,3,3-tetramethylbutyl)phenol, and non-benzotriazole containing UVAs such as hydroxyphenyl triazines (such as 6,6′-(6-(2,4-dibutoxyphenyl)-1,3,5-triazine-2,4-diyl)bis(3-butoxyphenol) (Tinuvin™ 460), cyanoacrylates (such as (E)-2-ethylhexyl 2-cyano-3-(4-methoxyphenyl)-3-phenylacrylate (Paraplex LS-300)), benzophenones, and the like.

Some terminology used throughout this application will be explained to provide a better understanding of the invention. The terms “polymer interlayer sheet,” “interlayer,” and “polymer melt sheet” as used herein, generally may designate a single-layer sheet or a multilayered interlayer. A “single-layer sheet,” as the names implies, is a single (or monolithic) polymer layer extruded as one layer. A multilayered interlayer, on the other hand, may comprise multiple layers, including separately extruded layers, co-extruded layers, or any combination of separately and co-extruded layers. Thus the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. As used herein, the terms “multilayer” and “multiple layers” mean an interlayer having more than one layer, and multilayer and multiple layer may be used interchangeably.

In various embodiments, the polymer composition may be used in an interlayer that is a single or monolithic interlayer comprising two or more resins (as discussed above). In embodiments, the single layer interlayer may comprise two or more poly(vinyl acetal) resins, such as two or more poly(vinyl acetal) resins having different levels of residual hydroxyl content (such as where the residual hydroxyl contents and/or the residual acetate contents are different), or the interlayer may be a single layer having one or more resins.

In various embodiments, the polymer composition may be used in multilayered interlayers where the multilayered interlayer comprises at least two polymer layers (e.g., a single layer or multiple layers co-extruded) disposed in direct contact with each other, wherein each layer comprises a polymer resin, as detailed more fully below. In embodiments, at least one layer of the multilayer interlayer, such as a skin layer or the core layer, comprises two (or more) different resins, such as two PVB resins having different residual hydroxyl content levels. As used herein for multilayer interlayers having at least three layers, “skin layer” generally refers to outer layers of the interlayer and “core layer” generally refers to the inner layer(s). Thus, one exemplary embodiment would be: skin layer//core layer//skin layer. It should be noted, however, further embodiments include interlayers having two layers, or more than three layers (e.g., 4, 5, 6, or up to 10 individual layers). Additionally, any multilayer interlayer utilized can be varied by manipulating the composition, thickness, or positioning of the layers and the like. For example, in one trilayer polymer interlayer sheet, the two outer or skin layers may comprise poly(vinyl butyral) (“PVB”) resin with a plasticizer or mixture of plasticizers, while the inner or core layer may comprise different PVB resin or a different thermoplastic material with a plasticizer and/or mixture of plasticizers. Thus, it is contemplated that the skin layers and the core layer(s) of the multilayered interlayer sheets may be comprised of the same thermoplastic material or different thermoplastic materials and the same or different plasticizer or plasticizers. Either or both layers may include additional additives as known in the art, as desired.

Although the embodiments described below refer to the polymer resin as being a poly(vinyl acetal) resin, such as PVB (which includes its isomer, polyvinyl isobutyral), it would be understood by one of ordinary skill in the art that the polymer may be any polymer suitable for use in a multiple layer panel. Typical polymers include, but are not limited to, poly(vinyl acetal) such as PVB, polyurethane, polyvinyl chloride, poly(ethylene-co-vinyl acetate) (EVA), combinations of the foregoing, and the like. PVB, EVA, ionomers and polyurethane are particularly useful polymers generally for interlayers; PVB is particularly suitable when used in conjunction with the interlayers of this disclosure comprising a UV absorber.

Prior to discussing the addition of the UV absorber selected to produce the composition or the interlayer having improved optical quality (color), some common components found in a polymer composition and an interlayer, both generally and in compositions and interlayers of the present disclosure, and the formation thereof will be discussed.

The PVB resin is produced by known acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Vinyl Acetal Polymers, in Encyclopedia of Polymer Science & Technology, 3rd edition, Volume 8, pages 381-399, by B. E. Wade (2003), the entire disclosures of which are incorporated herein by reference. The resin is commercially available in various forms, for example, as Butvar® Resin from Solutia Inc. (which is a wholly owned subsidiary of Eastman Chemical Company).

As used herein, residual hydroxyl content (calculated as % PVOH by weight) in PVB refers to the amount of hydroxyl groups remaining on the polymer chains after processing is complete. For example, PVB can be manufactured by hydrolyzing poly(vinyl acetate) to PVOH, and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished PVB resin, there typically will be residual acetate groups (as vinyl acetate groups) and residual hydroxyl groups (as vinyl alcohol groups) as side groups on the polymer chain. As used herein, residual hydroxyl content is measured on a weight percent basis per ASTM 1396.

In various embodiments, the PVB resin comprises about 8 to about 35 weight percent (wt. %) hydroxyl groups calculated as % PVOH, or about 9 to about 30 wt. %, about 10 to about 22 wt % hydroxyl groups calculated as % PVOH, although any level or combination of levels of residual hydroxyl groups is possible. The resin can also comprise less than 15 wt. % residual ester groups, less than 13 wt. %, less than 11 wt. %, less than 9 wt. %, less than 7 wt. %, less than 5 wt. %, or less than 1 wt. % residual ester groups calculated as polyvinyl ester, e.g., acetate, with the balance being an acetal, such as butyraldehyde acetal, but optionally being other acetal groups, such as an isobutyraldehyde acetal group, or a 2-ethyl hexanal acetal group, or a mix of any two of butyraldehyde acetal, isobutyraldehyde, and 2-ethyl hexanal acetal groups (see, for example, U.S. Pat. No. 5,137,954, the entire disclosure of which is incorporated herein by reference).

For a given type of plasticizer, the compatibility of the plasticizer in the PVB polymer is largely determined by the hydroxyl content of the polymer. PVB with greater residual hydroxyl content is typically correlated with reduced plasticizer compatibility or capacity, i.e., less plasticizer could be incorporated. Conversely, PVB with a lower residual hydroxyl content typically will result in increased plasticizer compatibility or capacity, i.e., more plasticizer could be incorporated. For some plasticizer types, such correlation might be reversed. Generally, this correlation between the residual hydroxyl content of a polymer and plasticizer compatibility/capacity will allow for addition of the proper amount of plasticizer to the polymer resin and more importantly, the ability to stably maintain differences in plasticizer content between multiple interlayers.

The PVB resin (or resins) of the present disclosure typically has a molecular weight of greater than 50,000 Daltons, or less than 500,000 Daltons, or about 70,000 to about 500,000 Daltons, or about 100,000 to about 425,000 Daltons, as measured by size exclusion chromatography using low angle laser light scattering. As used herein, the term “molecular weight” means the weight average molecular weight.

Various adhesion control agents (“ACAs”) can be used in the interlayers of the present disclosure to control the adhesion of the sheet to glass. In various embodiments of interlayers of the present disclosure, the interlayer can comprise about 0.003 to about 0.45 parts ACAs per 100 parts resin; about 0.01 to about 0.40 parts ACAs per 100 parts resin; and about 0.01 to about 0.10 parts ACAs per 100 parts resin. Such ACAs, include, but are not limited to, the ACAs disclosed in U.S. Pat. No. 5,728,472 (the entire disclosure of which is incorporated herein by reference), residual sodium acetate, potassium acetate, magnesium bis(2-ethyl butyrate), and/or magnesium bis(2-ethylhexanoate).

Other additives (in addition to the UV absorbers disclosed herein) may be incorporated into the interlayer to enhance its performance in a final product and impart certain additional properties to the interlayer. Such additives include, but are not limited to, dyes, pigments, antioxidants, anti-blocking agents, flame retardants, IR absorbers or blockers (e.g., indium tin oxide, antimony tin oxide, lanthanum hexaboride (LaBe) and cesium tungsten oxide), UV stabilizers, processing aides, flow enhancing additives, lubricants, impact modifiers, nucleating agents, thermal stabilizers, dispersants, surfactants, chelating agents, coupling agents, adhesives, primers, reinforcement additives, and fillers, among other additives known to those of ordinary skill in the art.

The interlayer can comprise 0 to about 100, 0 to about 80, about 0 to 45, about 10 to about 75, about 15 to about 60, about 25 to about 50, about 15 to about 50, about 10 to about 40, about 15 to about 40, about 25 to about 38, about 29 to about 32, and about 30 phr (parts per hundred parts resin) plasticizer or a mix of plasticizers. Of course, other quantities can be used as is appropriate for the particular application and the desired properties. In various embodiments of interlayers of the present disclosure, the interlayer will comprise greater than 5 phr, about 5 to about 100 phr, about 10 to about 80 phr, about 30 to about 60 phr, or less than 100 phr, or less than 80 phr total plasticizer. While the total plasticizer content is indicated above, the plasticizer content in the individual layers, such as the skin layer(s) or core layer(s) can be different from the total plasticizer content. In addition, the individual layers, such as the skin layer(s) and core layer(s), can have different plasticizer types and plasticizer contents, in the ranges previously discussed, as each respective layer's plasticizer content at the equilibrium state is determined by the layer's respective residual hydroxyl contents, as disclosed in U.S. Pat. No. 7,510,771 (the entire disclosure of which is incorporated herein by reference).

In some embodiments, examples of the plasticizer include esters of a polybasic acid or a polyhydric alcohol, among others. Suitable plasticizers include, for example, triethylene glycol di-(2-ethylhexanoate) (“3GEH”), triethylene glycol di-(2-ethylbutyrate), triethylene glycol diheptanoate, tetraethylene glycol diheptanoate, dihexyl adipate, dioctyl adipate, hexyl cyclohexyladipate, diisononyl adipate, heptylnonyl adipate, dibutyl sebacate, di(butoxyethyl) adipate, bis(2-(2-butoxyethoxy)ethyl) adipate, and mixtures thereof. In some embodiments, the plasticizer is 3GEH.

In some embodiments, the plasticizer may be a high refractive index plasticizer. Examples of high refractive index plasticizers include, but are not limited to, esters of a polybasic acid or a polyhydric alcohol, polyadipates, epoxides, phthalates, terephthalates, benzoates, toluoates, mellates and other specialty plasticizers, among others. Examples of suitable plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluoate, triethylene glycol di-o-toluoate, dipropylene glycol di-o-toluoate, 1,2-octyl dibenzoate, tri-2-ethylhexyl trimellitate, di-2-ethylhexyl terephthalate, bis-phenol A bis(2-ethylhexaonate), and mixtures thereof. Examples of particularly suitable high refractive index plasticizers are dipropylene glycol dibenzoates, tripropylene glycol dibenzoates, and 2,2,4-trimethyl-1,3-pentanediol dibenzoate.

Plasticizers work by embedding themselves between chains of polymers, spacing them apart (increasing the “free volume”) and thus significantly lowering the glass transition temperature (T_{g}) of the polymer resin (typically by 0.5 to 4° C./phr), making the material softer. In this regard, the amount of plasticizer in the interlayer can be adjusted to affect the glass transition temperature (T_{g}). The glass transition temperature (T_{g}) is the temperature that marks the transition from the glassy state of the polymer to the rubbery state. In general, higher amounts of plasticizer loading will result in lower T_{g}. Conventional interlayers generally have a T_{g} in the range of about 0° C. for acoustic (noise reducing) interlayer to about 45° C. for hurricane and aircraft interlayer applications. A particularly suitable T_{g} for certain embodiments is in the range of about 28° C. to about 35° C. for the standard or most common monolithic interlayer applications, and about −5° C. to about 5° C. for the core layer(s) in the trilayer acoustic interlayer applications, although other ranges are possible, depending on the desired properties and applications.

An interlayer's glass transition temperature is also correlated with the stiffness of the interlayer, and in general, the higher the glass transition temperature, the stiffer the interlayer. Generally, an interlayer with a glass transition temperature of 30° C. or higher increases windshield strength and torsional rigidity. A soft interlayer (generally characterized by an interlayer with a glass transition temperature of lower than 30° C.), on the other hand, contributes to the sound dampening effect (i.e., the acoustic characteristics). In some embodiments, the multilayered interlayers can be produced by combining these two advantageous properties (i.e., strength and acoustic) by utilizing harder or stiffer skin layers laminated with a softer core layer (e.g., stiff//soft//stiff) and softer skin layers laminated with a stiffer core layer (e.g., soft//stiff//soft). The skin layer in the multilayered interlayer can have glass transition temperatures of about 25° C. to about 40° C., about 20° C. to about 35° C., about 2500 to 35° C., about 2500 or greater, about 3000 or greater, and about 35° C. or greater, and core layer(s) of about 3900 or greater, about 3500 or greater, about 35° C. or less, about 10° C. or less, and about 4° C. or less. The interlayer of the present invention may be a single or monolithic interlayer sheet, or an interlayer sheet having any other number of layers, as desired.

Additionally, it is contemplated that polymer interlayer sheets as described herein may be produced by any suitable process known to one of ordinary skill in the art of producing polymer interlayer sheets that are capable of being used in a multiple layer panel (such as a glass laminate or a photovoltaic module or solar panel). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through the extrusion and co-extrusion processes. The final multiple layer glass panel laminate are formed using processes known in the art.

Generally, in its most basic sense, extrusion is a process used to create objects of a fixed cross-sectional profile. This is accomplished by pushing or drawing a material through a die of the desired cross-section for the end product.

Generally, in the extrusion process, thermoplastic resin and plasticizers, including any of those resins and plasticizers described above, as well as the UV absorbers, are pre-mixed and fed into an extruder device. Additives such as ACAs and colorants (in liquid, powder, or pellet form) are often used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product (or photovoltaic module).

The UV absorber may be any suitable UV absorber (or mixture of two or more UV absorbers) known in the art that can be incorporated into the polymer composition to produce a product having lower color and good optical clarity while also maintaining other desirable physical and mechanical properties. In other words, any UV absorber may be used, as long as it functions as a UV absorber to prevent chemical degradation, increased color or other optical clarity issues.

Examples of UV absorbers include, but are not limited to, benzotriazoles (BTZs), hydroxyphenyl triazines (HPTs), benzophenones (BPs), and cyanoacrylates (CAs), and combinations of the foregoing UV absorbers. Other examples of UV absorbers not necessarily falling in to the major classes of UV absorbers (BTZs, HPTs, BPs and CAs) include benzoxazinones (such as Cyasorb 3638), benzylidene malonates, and salicylate ester UV absorbers. The UV absorber may be liquid or solid, and may be mixed into the plasticizer prior to mixing with the resin and any additives, or added in any other manner desired.

The UV absorbers function by absorbing UV light and dissipating it as heat. In the ground state, BTZs, HPTs, and BPs contain an intramolecular hydrogen bond between the hydrogen atom of a phenol hydroxyl group and a hydrogen bond acceptor such as nitrogen or oxygen. Upon absorbing UV light, the hydrogen bond acceptor deprotonates the phenol hydroxyl group to form a high-energy intermediate. This high-energy intermediate can then revert to the ground state transferring the proton back to the phenol oxygen, reforming the intramolecular hydrogen bond, and giving off the absorbed energy from the UV light as heat.

Benzotriazoles function as shown below:

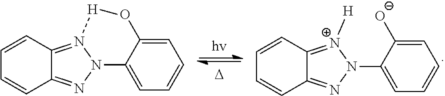

Hydroxyphenyl triazines function as follows:

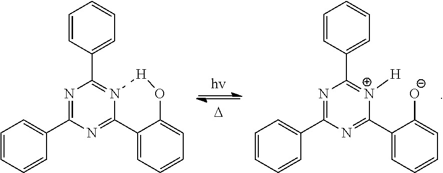

Benzophenones function as follows:

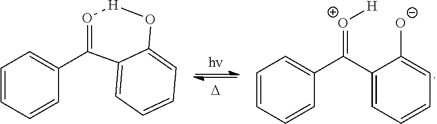

Cyanoacrylates function by a different mechanism. Upon absorbing light, the carbon-carbon double bond conjugated to the carbonyl group can form a diradical intermediate that can then rotate around the newly formed carbon-carbon single bond releasing the absorbed energy as heat and reforming the carbon-carbon double bond upon returning to the ground state.

Cyanoacrylates function as follows:

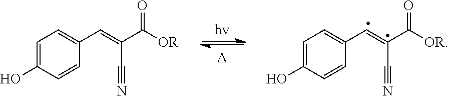

In some embodiments, the UV absorber may be a benzotriazole containing material. In embodiments, the UV absorber may be a UV absorber of the hydroxyphenyl benzotriazole class, such as a benzotriazole having the following structure (1):

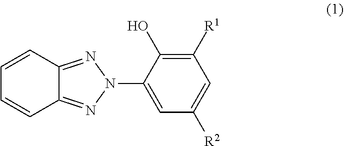

wherein R¹ and R² are each independently a C₁ to C₄₀ substituent, and at least one of R¹ and R² comprises an aryl substituent.

In embodiments, the UV absorber may be a benzotriazole such as 2-(2H-benzotriazol-2-yl)-4,6-bis(1-methyl-1-phenylethyl)phenol additive (e.g., Tinuvin™ 900) or 2-(2H-Benzotriazol-2-yl)-6-(1-methyl-1-phenylethyl)-4-(1,1,3,3-tetramethylbutyl)phenol additive (e.g., Tinuvin™ 928). The molecular structure of 2-(2H-benzotriazol-2-yl)-4,6-bis(1-methyl-1-phenylethyl)phenol (structure (2)) and 2-(2H-Benzotriazol-2-yl)-6-(1-methyl-1-phenylethyl)-4-(1,1,3,3-tetramethylbutyl)phenol (structure (3)) are provided below.

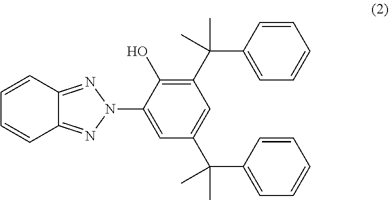 [SMILES: CC(C)(c1ccccc1)c1cc(-n2nc3ccccc3n2)c(O)c(C(C)(C)c2ccccc2)c1]

### 2-(2H-benzotriazol-2-yl)-4,6-bis(1-methyl-1-phenylethyl)phenol

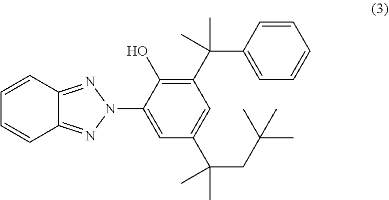 [SMILES: CC(C)(C)CC(C)(C)c1cc(-n2nc3ccccc3n2)c(O)c(C(C)(C)c2ccccc2)c1]

### 2-(2H-Benzotriazol-2-yl)-6-(1-methyl-1-phenylethyl)-4-(1,1,3,3-tetramethylbutyl)phenol

In embodiments, the UV absorber may be a UV absorber that is a cyanoacrylate (such as, for example, Uvinol 3035 or Paraplex LS-300), a hydroxyphenyl triazine (such as, for example, Tinuvin™ 400, Tinuvin™ 460 and Tinuvin™ 477 UV absorbers), or a benzophenone (such as Chimassorb 81 or Cyasorb UV-24 UV absorbers).

In some embodiments, the UV absorber may be the mixture of two or more UV absorbers, depending on the desired properties. In other embodiments, any of the aforementioned UVAs can be used in combination with one or more stabilizers such as, but not limited to, hindered amine light stabilizers, antioxidants, hindered phenols, and the like.

The UV absorber, which in some embodiments may be a benzotriazole containing UV absorber, is generally added in amounts of from about 0.01 to about 10 wt. %, or from about 0.05 to about 5 wt. %, or at least about 0.01 wt. %, or at least about 0.02 wt. %, or at least about 0.03 wt. %, or at least about 0.04 wt. %, or at least about 0.05 wt. %, or at least about 0.10 wt. %, or at least about 0.15 wt. %, or at least about 0.20 wt. %, or at least about 0.25 wt. %, or less than or equal to about 10 wt. %, or less than or equal to about 8 wt. %, or less than or equal to about 6 wt. %, or less than or equal to about 4 wt. %, or less than or equal to about 2 wt. %, or less than or equal to about 1 wt. %, or less than or equal to 0.9 wt. %, or less than or equal to 0.8 wt. %, or less than or equal to 0.7 wt. %, or less than or equal to 0.6 wt. %, or less than or equal to 0.5 wt. %. The UV absorber should be selected such it provides the desired UV absorption and does not adversely impact other properties of the final interlayer, such as the long term stability, adhesion, color (including color stability), haze, solubility in plasticizer, UV transmission and weathering as well as other properties.

In the extruder (or other mixing) device, the thermoplastic raw material, plasticizer(s) and UV absorber, and any other additives described above, are further mixed and melted, resulting in a melt that is generally uniform in temperature and composition. Once the melt reaches the end of the extruder device, the melt is propelled into the extruder die. The extruder die is the component of the thermoplastic extrusion process which gives the final polymer interlayer sheet product its profile. Generally, the die is designed such that the melt evenly flows from a cylindrical profile out of the die and into the product's end profile shape. A plurality of shapes can be imparted to the end polymer interlayer sheet by the die so long as a continuous profile is present.

Notably, for the purposes of this application, the polymer interlayer at the state after the extrusion die forms the melt into a continuous profile will be referred to as a “polymer melt sheet.” At this stage in the process, the extrusion die has imparted a particular profile shape to the thermoplastic resin, thus creating the polymer melt sheet. The polymer melt sheet is highly viscous throughout and in a generally molten state. In the polymer melt sheet, the melt has not yet been cooled to a temperature at which the sheet generally completely “sets.” Thus, after the polymer melt sheet leaves the extrusion die, generally the next step in presently employed thermoplastic extrusion processes is to cool the polymer melt sheet with a cooling device. Cooling devices utilized in the previously employed processes include, but are not limited to, spray jets, fans, cooling baths, and cooling rollers. The cooling step functions to set the polymer melt sheet into a polymer interlayer sheet of a generally uniform non-molten cooled temperature. In contrast to the polymer melt sheet, this polymer interlayer sheet is not in a molten state and is not highly viscous. Rather, it is the set final-form cooled polymer interlayer sheet product. For the purposes of this application, this set and cooled polymer interlayer will be referred to as the “polymer interlayer sheet.”

In some embodiments of the extrusion process, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

Generally, the thickness, or gauge, of the polymer interlayer sheet will be in a range from about 15 mils to 100 mils (about 0.38 mm to about 2.54 mm), about 15 mils to 60 mils (about 0.38 mm to about 1.52 mm), about 20 mils to about 50 mils (about 0.51 to 1.27 mm), and about 15 mils to about 35 mils (about 0.38 to about 0.89 mm). In various embodiments, each of the layers, such as the skin and core layers, of the multilayer interlayer may have a thickness of about 1 mil to 99 mils (about 0.025 to 2.51 mm), about 1 mil to 59 mils (about 0.025 to 1.50 mm), 1 mil to about 29 mils (about 0.025 to 0.74 mm), or about 2 mils to about 28 mils (about 0.05 to 0.71 mm).

As noted above, the interlayers of the present disclosure may be used as a single-layer sheet or a multilayered sheet. In various embodiments, the interlayers of the present disclosure (either as a single-layer sheet or as a multilayered sheet) can be incorporated into a multiple layer panel.

As used herein, a multiple layer panel can comprise a single substrate, such as glass, acrylic, or polycarbonate with a polymer interlayer sheet disposed thereon, and most commonly, with a polymer film further disposed over the polymer interlayer. The combination of polymer interlayer sheet and polymer film is commonly referred to in the art as a bilayer. A typical multiple layer panel with a bilayer construct is: (glass)//(polymer interlayer sheet)//(polymer film), where the polymer interlayer sheet can comprise multiple interlayers, as noted above. The polymer film supplies a smooth, thin, rigid substrate that affords better optical character than that usually obtained with a polymer interlayer sheet alone and functions as a performance enhancing layer. Polymer films differ from polymer interlayer sheets, as used herein, because polymer films do not themselves provide the necessary penetration resistance and glass retention properties, but rather provide performance improvements, such as infrared absorption characteristics. Poly(ethylene terephthalate) (“PET”) is the most commonly used polymer film, and in some cases, the PET film may be the base film or substrate, such as the substrate or base layer in a polymer film having, for example, a metallized coating. The use of a polymer film in place of one or more rigid substrate (such as glass) in a laminate results in a lighter weight glazing than a glazing having two rigid, thicker substrates. Generally, as used herein, a polymer film is thinner than a polymer sheet, such as from about 0.001 to 0.2 mm thick.

Further, the multiple layer panel can be what is commonly known in the art as a solar panel, with the panel further comprising a photovoltaic cell, as that term is understood by one of ordinary skill in the art, encapsulated by the polymer interlayer(s). In such instances, the interlayer is often laminated over the photovoltaic cell, with a construct such as: (glass)//(polymer interlayer)//(photovoltaic cell)//(polymer interlayer)//(glass or polymer film).

The interlayers of the present disclosure will most commonly be utilized in multiple layer panels comprising two substrates, preferably a pair of glass sheets (or other rigid materials, such as polycarbonate or acrylic, known in the art), with the interlayers disposed between the two substrates. An example of such a construct would be: (glass)//(polymer interlayer sheet)//(glass), where the polymer interlayer sheet can comprise a single layer interlayer or multilayered interlayers, as noted above. These examples of multiple layer panels are in no way meant to be limiting, as one of ordinary skill in the art would readily recognize that numerous constructs other than those described above could be made with the interlayers of the present disclosure.

The typical glass lamination process comprises the following steps: (1) assembly of the two substrates (e.g., glass) and interlayer; (2) heating the assembly via an IR radiant or convective means for a short period; (3) passing the assembly into a pressure nip roll for the first deairing; (4) heating the assembly a second time to about 50° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly at temperatures between 135° C. and 150° C. and at pressures between 150 psig and 200 psig for about 30 to 90 minutes.

Other means for use in de-airing of the interlayer-glass interfaces (steps 2-5) known in the art and that are commercially practiced include vacuum bag and vacuum ring processes in which a vacuum is utilized to remove the air.

Clarity is one measure of optical quality of a laminate. Clarity is determined by measuring the haze value or percent haze (% haze) and/or the percent transmittance (% T). Haze is a percentage of transmitted light that is scattered so that its direction deviates more than a specified angle from the direction of the incident beam. Haze may be measured using a haze meter or a spectrophotometer, such as HunterLab UltraScan XE instrument, or other haze meter known to one of skill in the art, and in accordance with ASTM D1003-Procedure B using Illuminant C, at an observer angle of 2 degrees. Percent transmittance (% T) or Transparency, is the percentage of the total incident light transmitted through the specimen, and may be determined according to ASTM D1003 as well.

In the Examples below, the % Tᵤᵥ of each laminate was measured using a Lambda 1050 spectrophotometer according to ISO13837 Convention A. The % T of the laminate was measured from 300 to 400 nm in 5 nm increments. The % T at each wavelength was multiplied by a specific factor and the results are summed to get % Tᵤᵥ.

The YI and % Haze of the laminate were measured using a HunterLab UltraScan XE according to ASTM Method D1925 for YI and ASTM Method ASTM D1003-61 for % Haze. Both YI and % Haze were measured on 30 mil (0.76 mm) interlayer.

The improved polymer compositions and interlayers comprising the compositions of the present disclosure have a percent haze of less than about 5%, or less than about 4.5%, or less than about 4%, or less than about 3.5%, or less than about 3%, or less than about 2.5%, or less than about 2%, or less than about 1.5%, or less than about 1%, or less than about 0.5%. The improved polymer compositions and interlayers comprising the compositions of the present disclosure have a % T of greater than 70%, or greater than 75%, or greater than 80%, or greater than 82%, or greater than 84%, or greater than 86%, or greater than 87%, or greater than 88%, if the interlayer is a clear interlayer. Interlayers having dyes or pigments may have a % T that is lower, as desired or as required for the particular application.

Adhesion was measured using the Pummel Adhesion test which was performed by cooling a laminate to −17.8° C. and manually pummeling the sample with a 1 lb. hammer on a steel plate at a 45° angle. After allowing the sample to come up to room temperature and removing the broken unadhered glass, the amount of glass left adhered to the interlayer is compared to a set of standards and assigned a rating of 0 to 9, with 0 meaning no glass is left adhered to the interlayer and 9 meaning all of the glass is still adhered to the interlayer.

The invention also includes Embodiments 1 to 13, as set forth below.

Embodiment 1 is a UV stable polymer interlayer comprising: a poly(vinyl acetal) resin; a plasticizer; and an ultraviolet absorber selected from hydroxyphenyl benzotriazoles, hydroxyphenyl triazines, benzophenones, cyanoacrylates, benzoxazinones, benzylidene malonates, and salicylate ester UV absorbers and combinations of the foregoing UV absorbers.

Embodiment 2 is a UV stable polymer interlayer including the features of embodiment 1, wherein the UV absorber is a hydroxyphenyl triazine UV absorber and is present in an amount of from about 0.01 to about 10 wt. %.

Embodiment 3 is a UV stable polymer interlayer including the features of embodiment 1, wherein the UV absorber is a benzophenone UV absorber and is present in an amount of from about 0.01 to about 10 wt. %.

Embodiment 4 is a UV stable polymer interlayer including the features of embodiment 1, wherein the UV absorber is a cyanoacrylate UV absorber and is present in an amount of from about 0.01 to about 10 wt. %.

Embodiment 5 is a UV stable polymer interlayer including the features of embodiment 1, wherein the UV absorber is a benzoxazinone UV absorber and is present in an amount of from about 0.01 to about 10 wt. %.

Embodiment 6 is a UV stable polymer interlayer comprising: a poly(vinyl butyral) resin; a plasticizer; and an ultraviolet absorber comprising structure (1)

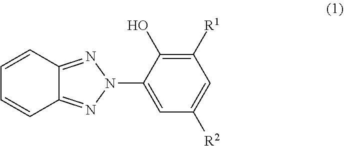

wherein R¹ and R² are each independently a C₁ to C₄₀ substituent, and at least one of R¹ and R² comprises an aryl substituent.

Embodiment 7 is a UV stable polymer interlayer including the features of embodiment 6, wherein the ultraviolet absorber comprises structure (2) (2).

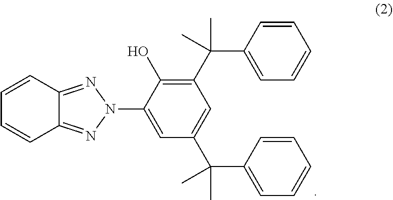 [SMILES: CC(C)(c1ccccc1)c1cc(-n2nc3ccccc3n2)c(O)c(C(C)(C)c2ccccc2)c1]

Embodiment 8 is a UV stable polymer interlayer including the features of embodiment 6, wherein the ultraviolet absorber comprises structure (3)

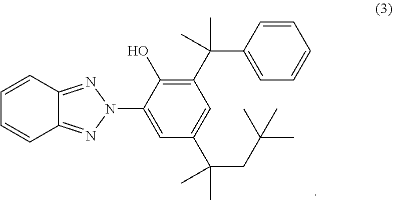 [SMILES: CC(C)(C)CC(C)(C)c1cc(-n2nc3ccccc3n2)c(O)c(C(C)(C)c2ccccc2)c1]

Embodiment 9 is a UV stable polymer interlayer including the features of any of embodiments 1 to 8, wherein the ultraviolet absorber is present in an amount of 0.01 to about 10 wt. % and comprises 2-(2H-benzotriazol-2-yl)-4,6-bis(1-methyl-1-phenylethyl)phenol or 2-(2H-Benzotriazol-2-yl)-6-(1-methyl-1-phenylethyl)-4-(1,1,3,3-tetramethylbutyl)phenol or a mixture thereof.

Embodiment 10 is a UV stable polymer interlayer comprising: a poly(vinyl butyral) resin; a plasticizer; and an ultraviolet absorber comprising 2-(2H-benzotriazol-2-yl)-4,6-bis(1-methyl-1-phenylethyl)phenol or 2-(2H-Benzotriazol-2-yl)-6-(1-methyl-1-phenylethyl)-4-(1,1,3,3-tetramethylbutyl)phenol or a mixture thereof.

Embodiment 11 is a UV stable polymer interlayer including the features of any of embodiments 1 to 10, wherein the ultraviolet absorber is present in an amount of 0.01 to about 10 wt. %.

Embodiment 12 is a UV stable polymer interlayer including any of the features of embodiments 1 to 11, wherein the polymer interlayer has a % T of at least 80% (ASTM D1003-Procedure B using Illuminant C), a % Tᵤᵥ is less than or equal to 12 (as measured by ISO13837 Convention A on a 30 mil interlayer) and a yellowness index (YI) of less than or equal to 2 (as measured by ASTM D1925 on a 30 mil interlayer).

Embodiment 13 is a multiple layer glass panel including any of the UV stable polymer interlayers of embodiments 1 to 12.

### EXAMPLES

To test various different ultraviolet absorbers (UVAs) and their effectiveness in poly(vinyl butyral) (PVB) interlayers, PVB formulations containing different types of UVAs were produced and evaluated for optical properties and adhesion. The different UVAs were incorporated into PVB formulations (as further described below) and evaluated for % Tᵤᵥ and YI at a concentration of 0.4 pounds per hundred pounds resin (phr). The UVAs with good optical performance were then incorporated into formulations and extruded on a 1.25″ extruder, and the laminates made from the resulting sheet were evaluated for optical performance and adhesion.

Table 1 shows the % Tᵤᵥ and YI performance of the UVAs of different classes at a concentration of 0.4 phr that were tested. For comparison, T326 and T328 were included at the concentrations that are used in current interlayer products. From the data in Table 1, T900 and T928 seem to be the best replacement candidates due to similar % Tᵤᵥ and low YI, while T460 and P300 had good performance as well.

TABLE 1

| | Class of | | | |
|---|---|---|---|---|
| Entry | UVA | UVA (0.4 phr) | % Tᵤᵥ | YI |
| 1 | BZT | Tinuvin 326* (T326) | 2.15 | 0.84 |
| 2 | | Tinuvin 328* (T328) | 9.19 | 0.35 |
| 3 | | Tinuvin 900 (T900) | 9.05 | 0.12 |
| 4 | | Tinuvin 928 (T928) | 9.97 | −0.20 |
| 5 | | Eversorb 78 (E78) | 8.00 | 0.72 |
| 6 | | Eversorb 82 (E82) | 12.39 | 0.24 |
| 7 | | Eversorb 109 (E109) | 3.28 | 0.94 |
| 7 | HPT | Tinuvin 400 (T400) | 27.35 | −0.15 |
| 8 | | Tinuvin 460 (T460) | 8.48 | 0.77 |
| 9 | | Tinuvin 477 (T477) | 2.66 | 6.30 |
| 10 | | Tinuvin 1600 (T1600) | 10.91 | 0.84 |
| 11 | BP | Chimassorb 81 (C81) | 24.62 | 0.52 |
| 12 | | Cyasorb UV-24 (C24) | 1.42 | 16.58 |
| 13 | | Eversorb 51 (E51) | 0.08 | 31.38 |
| 14 | | Eversorb 52 (E52) | 0.51 | 20.39 |
| 15 | CA | Uvinol 3035 (U3035) | 40.04 | −0.08 |
| 16 | | Paraplex LS-300 (P300) | 4.32 | 1.68 |
| 17 | Other | Cyasorb UV-3638 | 25.98 | 0.13 |
| | | (C3638) | | |
| 18 | | 2-ethylhexyl salicylate | 63.3 | −0.41 |
| | | (2EH salicylate) | | |

*Tinuvin 326 was tested at 0.25 phr, Tinuvin 328 was tested at 0.35 phr

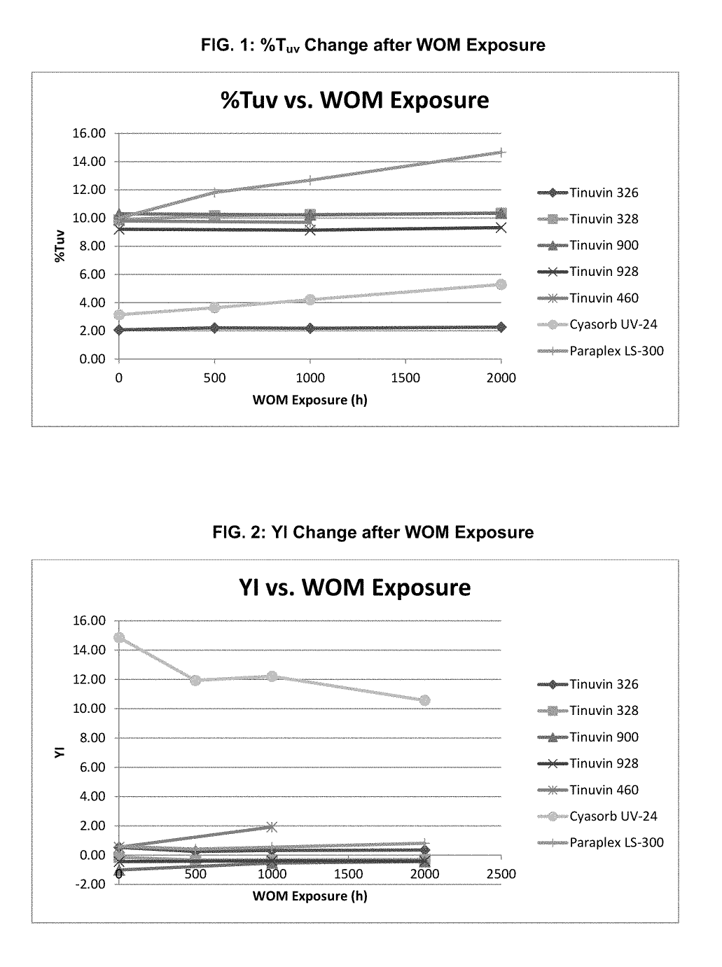

The UVAs having good optical properties (a combination of good YI and % Tᵤᵥ, as shown in Table 1) that were selected for further evaluation and weatherometer data were extruded on a 1.25″ extruder to obtain better measurements of optical properties as well as adhesion, as described above. The UVAs further tested include: T900, T928, T460, C24 and Paraplex LS-300. For controls, T326 and T328 were also used. For each UVA composition, 285 grams of plasticizer (3GEH) were weighed out into a glass jar. To this jar, 0.1 to 0.4 phr of the UVA (as shown in Tables 2 and 3 below) and other common additives were added. The jar was then heated in a water bath at 50′C while being stirred with an overhead mixer using a high shear mixing blade for up to an hour to form a homogeneous solution. The plasticizer solution was then added to 750 grams of PVB resin and mixed in a standing mixer until combined to form a premix. The premix was then extruded using a 1.25″ extruder, producing 30 gauge 0.76 mm) sheet. The sheet was laminated as described above except that the laminate size was 3×5.5″ to accommodate the weatherometer testing. Samples were prepared as described above, and samples were tested for weathering. Weatherometer (WOM) data is shown in FIGS. 1 and 2 and Tables 2 and 3 below.

TABLE 2

| | | Concen- | | | | |
|---|---|---|---|---|---|---|
| | | tration | % Tuv vs. WOM Exposure (hours) | | | |
| Case | UVA | (phr) | 0 | 500 | 1000 | 2000 |
| 1 | Tinuvin 326 | 0.25 | 2.07 | 2.21 | 2.18 | 2.26 |
| | (T326) | | | | | |
| 2 | Tinuvin 328 | 0.35 | 9.87 | 10.16 | 10.24 | 10.33 |
| | (T328) | | | | | |
| 3 | Tinuvin 900 | 0.4 | 10.3 | — | 10.22 | 10.35 |
| | (T900) | | | | | |
| 4 | Tinuvin 928 | 0.4 | 9.2 | — | 9.14 | 9.32 |
| | (T928) | | | | | |
| 5 | Tinuvin 460 | 0.35 | 9.79 | — | 9.69 | — |
| | (T460) | | | | | |
| 6 | Cyasorb UV-24 | 0.3 | 3.14 | 3.64 | 4.21 | 5.29 |
| | (C24) | | | | | |
| 7 | Paraplex LS-300 | 0.2 | 10.00 | 11.81 | 12.68 | 14.66 |
| | (P300) | | | | | |

TABLE 3

| | | Concen- | | | | |
|---|---|---|---|---|---|---|
| | | tration | YI vs. WOM Exposure (hours) | | | |
| Case | UVA | (phr) | 0 | 500 | 1000 | 2000 |
| 1 | Tinuvin 326 | 0.25 | 0.53 | 0.25 | 0.32 | 0.35 |
| | (T326) | | | | | |
| 2 | Tinuvin 328 | 0.35 | −0.14 | −0.34 | −0.32 | −0.30 |
| | (T328) | | | | | |
| 3 | Tinuvin 900 | 0.4 | −1.01 | — | −0.54 | −0.44 |
| | (T900) | | | | | |
| 4 | Tinuvin 928 | 0.4 | −0.44 | — | −0.39 | −0.4 |
| | (T928) | | | | | |
| 5 | Tinuvin 460 | 0.35 | 0.55 | — | 1.92 | — |
| | (T460) | | | | | |
| 6 | Cyasorb UV-24 | 0.3 | 14.86 | 11.93 | 12.21 | 10.57 |
| | (C24) | | | | | |
| 7 | Paraplex LS-300 | 0.2 | 0.59 | 0.41 | 0.54 | 0.81 |
| | (P300) | | | | | |

All of the UVAs further evaluated (in Tables 2 and 3) showed adhesion comparable to the control cases with current UVAs, T326 and T328. For % Tᵤᵥ and YI, the UVAs showed the same trends that were observed with the testing previously completed. Two BZT UVAs, T900 and T928, had good adhesion response and optical properties. Another UVA, T460, had similar performance to T328 in terms of % Tᵤᵥ but YI was higher. At a level of 0.2 phr, P300 had a UV performance similar to T328 but YI was also higher (YI=0.60). Two BZT UVAs, T900 and T928, have been identified as the best UVA candidates for interlayers to replace the current UVA, T328. Both perform similarly to T328 and have slightly lower YI values.

Two non-BZT UVAs have also had good results when used in an interlayer. One UVA, T460, from the HPT family of UVAs, had UV performance similar to T328 with slightly higher YI. A second UVA, P300 from the CA family of UVAs, also had UV performance similar to T328 with slightly higher YI values. Non-BZT UVAs are currently more expensive than T328, making it more costly to produce an interlayer having the same or similar UV properties, but are effective in providing the UV absorption desired while maintaining the optical properties, adhesion levels and other important properties of the interlayer.

In conclusion, the Examples show that various UV stable polymer interlayers can be produced with various UV absorbers, such as hydroxyphenyl benzotriazoles, hydroxyphenyl triazines, benzophenones, cyanoacrylates, benzoxazinones, benzylidene malonates, and salicylate ester UV absorbers as well as combinations of the foregoing UV absorbers, where the polymer interlayer has acceptable optical properties (% Tᵤᵥ and YI). Particularly suitable UV absorbers include ultraviolet absorber comprising structure (1)

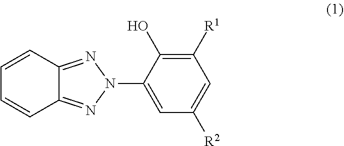

wherein R¹ and R² are each comprise at least one aryl group, and in particular, hydroxyphenyl benzotriazoles comprising structure (2) and/or structure (3). Other advantages will be readily apparent to those skilled in the art.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, an interlayer can be formed comprising poly(vinyl butyral) having a residual hydroxyl content in any of the ranges given in addition to comprising a plasticizers in any of the ranges given to form many permutations that are within the scope of the present disclosure, but that would be cumbersome to list. Further, ranges provided for a genus or a category, such as anhydrides, can also be applied to species within the genus or members of the category, such as hexahydro-4-methylphthalic anhydride or phthalic anhydride, unless otherwise noted.

What is claimed is:

1. A UV stable polymer interlayer comprising:
a poly(vinyl butyral) resin;
a plasticizer; and
an ultraviolet absorber comprising structure (1) 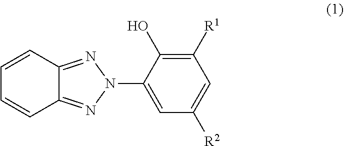
wherein R¹ and R² are each independently a C₁ to C₄₀ substituent, and at least one of R¹ and R² comprises an aryl substituent.

2. The polymer interlayer of claim 1, wherein the ultraviolet absorber comprises structure (2)

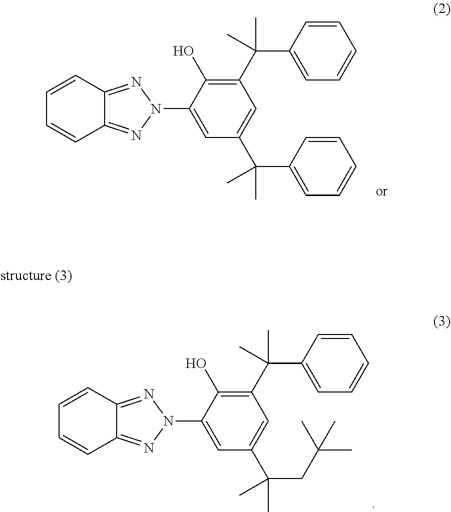 [SMILES: CC(C)(c1ccccc1)c1cc(-n2nc3ccccc3n2)c(O)c(C(C)(C)c2ccccc2)c1 ; CC(C)(C)CC(C)(C)c1cc(-n2nc3ccccc3n2)c(O)c(C(C)(C)c2ccccc2)c1]

3. The polymer interlayer of claim 2, wherein the ultraviolet absorber comprises structure (2)

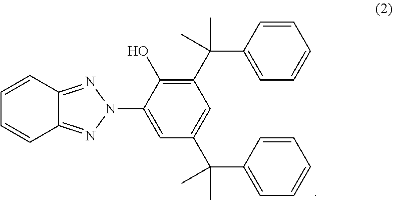 [SMILES: CC(C)(c1ccccc1)c1cc(-n2nc3ccccc3n2)c(O)c(C(C)(C)c2ccccc2)c1]

4. The polymer interlayer of claim 2, wherein the ultraviolet absorber comprises structure (3)

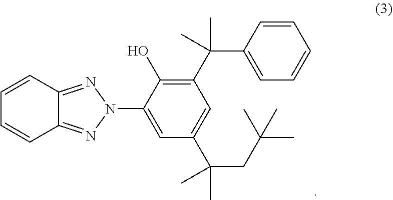 [SMILES: CC(C)(C)CC(C)(C)c1cc(-n2nc3ccccc3n2)c(O)c(C(C)(C)c2ccccc2)c1]

5. The polymer interlayer of claim 1, wherein the ultraviolet absorber is present in an amount of 0.01 to about 10 wt. %.

6. The polymer interlayer of claim 1, wherein the polymer interlayer has a % T of at least 80% (ASTM D1003-Procedure B using Illuminant C), a % Tᵤᵥ is less than or equal to 12 (as measured by ISO13837 Convention A on a 30 mil interlayer) and a yellowness index (YI) of less than or equal to 2 (as measured by ASTM D1925 on a 30 mil interlayer).

7. The polymer interlayer of claim 6, wherein the ultraviolet absorber is present in an amount of 0.01 to about 10 wt. % and comprises 2-(2H-benzotriazol-2-yl)-4,6-bis(1-methyl-1-phenylethyl)phenol or 2-(2H-benzotriazol-2-yl)-6-(1-methyl-1-phenylethyl)-4-(1,1,3,3-tetramethylbutyl)phenol or a mixture thereof.

8. A multiple layer glass panel comprising the polymer interlayer of claim 1.

9. A UV stable polymer interlayer comprising:
a poly(vinyl butyral) resin;
a plasticizer; and
an ultraviolet absorber comprising 2-(2H-benzotriazol-2-yl)-4,6-bis(1-methyl-1-phenylethyl)phenol or 2-(2H-benzotriazol-2-yl)-6-(1-methyl-1-phenylethyl)-4-(1,1,3,3-tetramethylbutyl)phenol or a mixture thereof.

10. The polymer interlayer of claim 9, wherein the polymer interlayer has a % T of at least 80% (ASTM D1003-Procedure B using Illuminant C), a % Tᵤᵥ is less than or equal to 12 (as measured by ISO13837 Convention A on a 30 mil interlayer) and a yellowness index (YI) of less than or equal to 2 (as measured by ASTM D1925 on a 30 mil interlayer).

11. The polymer interlayer of claim 9, wherein the ultraviolet absorber is present in an amount of 0.01 to about 10 wt. %.

12. The polymer interlayer of claim 9, wherein the ultraviolet absorber comprises 2-(2H-benzotriazol-2-yl)-4,6-bis(1-methyl-1-phenylethyl)phenol.

13. The polymer interlayer of claim 9, wherein the ultraviolet absorber comprises 2-(2H-benzotriazol-2-yl)-6-(1-methyl-1-phenylethyl)-4-(1,1,3,3-tetramethyl butyl)phenol.

14. A multiple layer glass panel comprising the polymer interlayer of claim 9.
